(19) United States
(12) Patent Application Publication
(10) Pub. No.: US 2014/0287976 A1
(43) Pub. Date: Sep. 25, 2014

(54) ENVIRONMENTALLY SAFE CLEANING SOLUTION

(71) Applicant: Steven F. Brindamour, Sumner, WA (US)

(72) Inventor: Steven F. Brindamour, Sumner, WA (US)

(21) Appl. No.: 14/222,582

(22) Filed: Mar. 21, 2014

Related U.S. Application Data
(63) Continuation-in-part of application No. 13/533,458, filed on Jun. 26, 2012.
(60) Provisional application No. 61/571,453, filed on Jun. 27, 2011.

(51) Int. Cl. C11D 3/395; C11D 3/00; C11D 3/04

(52) U.S. Cl. CPC C11D 3/3956; C11D 3/04; C11D 3/0015
USPC 510/380

(57) ABSTRACT

An environmentally safe cleaning solution, which can be employed to aggressively clean all common materials, including those conventionally only dry-cleaned, without damage to these materials, and without employing toxic or environmentally hazardous components. The cleaning solution includes liquid detergent, fabric softener, ammonia, household bleach, and liquid dish soap, mixed with distilled water. A preferred alternative mixture also includes potassium chloride. The mixture quickly stabilizes without degradation or separation on prolonged storage.

### CROSS-REFERENCE TO RELATED APPLICATIONS

This Non-Provisional Utility patent application is a Continuation-in-part of Non-Provisional Utility patent application Ser. No. 13/533,458, filed Jun. 26, 2012 and now pending, which claims the benefit of U.S. Provisional Application 61/571,453, filed Mar. Jun. 27, 2011. Each patent application and prosecutional history identified above is incorporated herein by reference in its entirety, to provide continuity of disclosure.

### TECHNICAL FIELD

The invention relates to an environmentally safe cleaning solution. Specifically, the solution of the present invention can be employed to aggressively clean all common materials, including those conventionally only dry-cleaned, without damage to these materials, and without employing toxic or environmentally hazardous components

### BACKGROUND OF THE INVENTION

Cleaning solutions have a long industrial history. As early as the 1930's, detergents with bleaching agents, such as hypochlorite, were regarded as effective bactericides. In the 1960's, the advent of home dishwashers led to several improvements to detergent solutions that included the addition of surfactants. However, no prior formulations are found to include bleaching action with an aggressive cleaning action, in a safe and environmentally benign solution. Therefore, a cleaning solution is needed that aggressively cleans all common materials, including fabrics conventionally only dry-cleaned, without damage to these materials, and without employing toxic or environmentally hazardous components.

The following is a disclosure of the present invention that will be understood by reference to the following detailed description.

### DETAILED DESCRIPTION OF SPECIFIC EMBODIMENTS

The present invention provides an environmentally safe cleaning solution, which is based upon a mixture of known chemicals that produces a gentle, yet extraordinarily effective detergent blend. Specifically, the invention comprises a mixture of a liquid detergent, a fabric softener, an ammonia, a bleach and a liquid soap, which combine with a mild reaction, to result in a novel and hybrid cleaning solution that is very effective in use of a wide variety of stains, dirt and grime, while remaining gentle on dyes and colors in fabrics and materials. The hybrid cleaning solution of the present invention is not corrosive and is not considered toxic.

Liquid detergent is a preferred component of the hybrid cleaning solution of the present invention. Commercially available liquid detergent commonly includes well known surfactants, buffer agents and stabilizers, and optionally contains brightener agents and fragrance chemicals. Preferably, for use with the present invention, liquid detergents with brightener agents and fragrance chemicals are not employed. However, fragrance can be added in an alternative embodiment of the present invention, especially if not included in any of the component ingredients of the hybrid cleaning solution. Buffer Agents in liquid detergents typically aid in resisting pH changes caused by the other ingredients in the liquid and generally consist of various commonly known alcohols, esters and sugars and salts. Stabilizers in the liquid detergent are added typically, in order to keep the various ingredients in detergent in a constant liquid state and avoid separation. It is conventionally known that most stabilizers are some form of polyalkylene oxide or ethylene oxide, which is a synthetic chemical that keeps all the other ingredients emulsified. Natural detergents often use some type of enzyme stabilizer such as boric acid. Calcium salts may also be employed to stabilize these compositions.

Unlike powdered detergent, liquid detergent is mixed with a liquid base, making it easier to dissolve in water, brightener agents and fragrance chemicals. Surfactants can be from both natural and synthetic origins. Synthetic surfactants are generally derived from petroleum or phosphate compounds. Natural surfactants are commonly derived from sources such as palm oil, coconut oil or tallow. Many laundry detergents will include both anionic and ionic surfactants. The anionic surfactants are excellent grease removers and the ionic make the detergent less hardness-sensitive. Other detergents will use various cleaning agent surfactants, including baking soda, soap-bark, or plant-derived surfactants, such as those made from soy, could be utilized.

Fabric softener is an additional preferred component of the hybrid cleaning solution of the present invention. Fabric softeners are also well known commercially, and typically include di-hydrogenated tallow dimethyl ammonium chloride (DHTDMAC), or similar acting quaternary ammonium compounds, also referred to as “quats,” or alternatively the fabric softener can include a Polydimethylsiloxane (PDMS), along with commonly employed emulsifiers, fragrances and color. Preferably, for use with the present invention, fabric softeners with color and fragrance chemicals are not employed. However, fragrance and color can be added, if desired.

Ammonia is an additional preferred component of the hybrid cleaning solution of the present invention. Most preferably, the ammonia is in a water solution, usually in the range of five to ten weight percent ammonia, or NH₃, as typical for ‘household’ solutions of ammonia, which is a dilute solution of ammonium NH₄⁺ ions in water, associated with hydroxide OH⁻ anions, and commonly thought to dissociate as follows:

NH₃+H₂O [symbol] NH₄⁺+OH⁻ (Equation 1.1)

Dilute sodium hypochlorite in a water solution is commonly referred to as “bleach” or “household bleach.” Bleach is an additional preferred component of the hybrid cleaning solution of the present invention. It is widely considered that mixing bleach with some household cleaners can be hazardous. For example, mixing an acid cleaner with bleach can generate chlorine gas, while mixing with ammonia solutions often produces chloramines, likely by the following reactions:

NH₄OH+NaClO [symbol] NaOH+NH₂Cl+H₂O (Equation 2.1)

NH₂Cl+NaOCl→NaOH+NHCl₂ (Equation 2.2)

NHCl₂+NaOCl→NaOH+NCl₃ (Equation 2.3)

Possible additional reactions produce hydrazine, in a variation of the conventional “Olin-Raschig” process:

NH₃+NH₂Cl+NaOH→N₂H₄+NaCl+H₂O (Equation 3.1)

The hydrazine generated may further react with the monochloramine in an exothermic reaction:

2[NH₂Cl]+N₂H₄→2[NH₄Cl]+N₂ (Equation 4.1)

One concern arising from sodium hypochlorite or bleach use is that it may form chlorinated organic compounds, which can occur during household storage and use. However, for the hybrid cleaning solution of the present invention, no hazardous organic compounds were present above standard detectable threshold limits, in laboratory analysis.

Liquid dish soap is conventionally a mixture of either synthetic or natural plant oils, with a water-soluble alkali salt, along with conventional fragrances and dyes. Liquid dish soap is an additional preferred component of the hybrid cleaning solution of the present invention. Synthetic dish soap typically contains petroleum-based ingredients. Natural oil liquid dish soap typically uses plant oils and a water-soluble alkali salt. Some available liquid dish soap formulations contain a non-toxic “oxygen bleach” for extra cleaning power.

The exact ration of these above listed ingredients for use in the hybrid cleaning solution of the present invention can vary, depending on the desired use. However, the hybrid cleaning solution of the present invention may momentarily warm and ‘fizz’ upon initial mixing, which may indicate that nitrogen gas may be evolving, per Equation 4.1, above. Importantly, the hybrid cleaning solution of the present invention is very effective in use of a wide variety of stains, dirt and grime, while remaining gentle on dyes and colors, and not corrosive or toxic.

An additional component for the hybrid cleaning solution of the present invention is a potassium chloride salt, which significantly enhances the cleaning power of the formulation. Specifically, a small amount of the potassium chloride salt in the range of 1 to 10 teaspoons per 10 gallons of product, improve the cleaning action of the formula, with a preferred addition at approximately 1 to 2 teaspoons of the potassium chloride per 10 cups of undiluted mixture. Example 3, below, illustrates a preferred mixture using the potassium chloride salt. The quantity of added potassium chloride salt is important, in that too much salt will not dissolves into solution, and greatly increases the viscosity of the resultant formulation. Potasium salt is preferred, instead of other neutral salts, in that it is readily available, yet superior to sodium chloride in action, and does not contribute to hard water as calcium chloride. Alkali salts are not preferred for use, because of the base reactions and the increase to pH imparted to the formulated mixture.

### EXAMPLE 1

The following ingredient amounts are preferred, and employed in a working example of the hybrid cleaning solution of the present invention. In a five gallon mixer, 3.5 cups of the liquid detergent, 3.5 cups of the fabric softener, 0.5 cups of the ammonia, 0.25 cups of the household bleach, 0.25 cups of the liquid dish soap, and approximately 10 cups of distilled water were added and gently stirred. The mixture slightly warms and fizzes, but quickly stabilizes without degradation or separation on prolonged storage.

The term “approximately” is used herein to refer to a range of values or relative orientations, understood by a person skilled in the pertinent field or skill, as being substantially equivalent to the herein stated values in achieving the desired results, a range typical to the accuracy and precision of conventional tooling, instrumentation or techniques, or a functionally equivalent range of features that produce equivalent results to those described herein.

The liquid detergent, fabric softener, ammonia and bleach were all common “off-the shelf” available products, as branded “HOMELIFE” and distributed by the Albertson's Corporation, of Boise Id. The liquid dish soap employed was “DAWN” brand of liquid dish soap, as manufactured by the Proctor and Gamble Co., of Cincinnati Ohio.

This formulation was extraordinarily effective on all typical fabric and material, specifically including wool, silk, leather, fur, and snake skin, with results similar to dry cleaning, but employed in a conventional washing machine. Additional uses include a cleaner and polishing agent for vehicles, and as a plant and grass food.

### EXAMPLE 2

The hybrid cleaning solution of the present invention was employed to clean a boiler “steam trap.” Prior to treatment of the trap, the operating pressure gauge were checked, the pressure gauge read 80 psig. The treatment included pouring approximately two cups of the hybrid cleaning solution into the steam trap and running the boiler as normal. After treatment, and within ten days following the treatment, the pressure gauge again and it read 110 psig, at the same operating temperature, which corresponds to a substantial increase in boiler operating efficiency.

### EXAMPLE 3

The following ingredient amounts are preferred, and employed in an additional alternative working example of the hybrid cleaning solution of the present invention. In an approximately two gallon mixer, 5.5 cups (44 fluid ounces) of the liquid detergent, 4.75 cups (38 fluid ounces) of the fabric softener, 0.75 cups (6 fluid ounces) of the ammonia, 1 cup (8 fluid ounces) of the household bleach, 1.5 cups (12 fluid ounces) of the liquid dish soap are mixed. Additionally, 2 teaspoons (0.33 fluid ounces) of solid potassium chloride salts, with the salts pre-dissolved in approximately 2 fluid ounces of water (preferably distilled), are combined in the mixer and gently stirred. The mixture slightly warms and fizzes, but quickly stabilizes without degradation or separation on prolonged storage. This preferred formulation was extraordinarily effective on all typical fabric and material, with results similar to dry cleaning, but used in a conventional washing machine.

As with the hybrid cleaning solution of Example 1, in this alternative formulation the liquid detergent, fabric softener, ammonia and bleach were all common “off-the shelf” available products, as branded “HOMELIFE” and distributed by the Albertson's Corporation, of Boise Id. A sample of the commercially available HOMELIFE™ fabric softener is analyzed in Table 1, below, and a sample of the commercially available HOMELIFE™ laundry soap is analyzed in Table 2, below. The liquid dish soap employed was “DAWN” brand of liquid dish soap, as manufactured by the Proctor and Gamble Co., of Cincinnati Ohio. A sample of the commercially available DAWN™ liquid dish soap was analyzed by a using conventional Gas Chromatography-Mass Spectroscopy (GC-MS), with the results shown in Table 3, below. Additionally, Table 4 demonstrates that the hybrid cleaning solution is approximately a composite of the components as analyzed in Tables 1 through 3.

For the preferred embodiments of the present invention, several of the off-the-shelf ingredients, as well as the hybrid cleaning solution closely approximating the alternative preferred formulation of Example 3, were analyzed using conventional Gas Chromatography-Mass Spectroscopy (GC-MS), which is a standard technique used to identify and quantify volatile organic compounds within a sample. GC-MS works by breaking down samples into their components, separating them in a heated column, and analyzing each component with a mass spectrometer. Each component of a target sample volatilizes and travels through the column of the GC-MS at a “retention time.” GC-MS is especially useful in material characterization and identification. The results utilize the well-recognized National Institute of Standards and Technology (NIST) GC-MS spectral database, to provide accurate analysis of the components and formulations, ranked by the similarity to the analyzed target spectrum according to a mathematically computed “Match Factor.”

The Match Factor indicates the likelihood that the target sample spectrum and the reference NIST spectrum arose from the same compound. Technically, the Match Factor is the normalized dot product with square-root scaling of the submitted multi-spectrum and the NIST library multi-spectrum, using all the elements in the submitted multi-spectrum. The Match Factor has a numerical value between 0 and 999, with indicating how closely all the peaks in the sample's spectrum match the peaks in the database spectrum. The higher the Match factor, the higher the likelihood of a mass spectrographic match. Typically, Match Factor values near and above 700 are considered confirmatory matches. The following Tables summarize results of the compounds, as analyzed:

TABLE 1
NIST Best Match Compounds for “FABRIC SOFTENER”

| Retention | | | Abun- |
|---|---|---|---|
| Time | | Match | dance |
| (minutes) | Compound | Factor | (10*5) |
| 11.646 | 3,4-Octadiene, 7,7-dimethyl- | 634 | 0.1 |
| 14.855 | 9-Phenanthrenernethyl naphthalene2Lacetate | 644 | 0.4 |
| 16.187 | Galaxolide 1 | 837 | 0.3 |

TABLE 2
NIST Best Match Compounds for “LAUNDRY SOAP”

| Retention | | | |
|---|---|---|---|
| Time | | Match | Abundance |
| (minutes) | Compound | Factor | (10*5) |
| 10.183 | 1-Octanethiol | 709 | 2.0 |
| 10.700 | Octanoic Acid | 862 | 6.9 |
| 11.852 | Decanoic acid, methyl ester | 806 | 1.1 |
| 12.378 | n-Decanoic acid | 780 | >4.1 |
| 13.187 | E-11, 13-Tetradecadien-1-ol | 843 | 1.0 |
| 13.529 | Dodecanoic acid, methyl ester | 933 | 14.9 |
| 13.968 | Dodecanoic acid | 945 | 20.3 |
| 14.768 | 1-Hexanol, 3-methyl- | 727 | 0.2 |
| 15.080 | Methyl tetradecanoate | 889 | 5.7 |
| 16.179 | Galaxolide 1 | 786 | 0.3 |
| 16.462 | Hexadecanoic acid, methyl ester | 822 | 1.7 |
| 16.986 | Diethylene glycol monododecyl ether | 764 | 1.2 |
| 17.315 | 1,2:5,6-Dianhydrogalactitol | 624 | 1.5 |
| 17.598 | Cyciopentane, 1-methyl-3-(2-methylpropyl)- | 663 | 0.7 |
| 17.740 | Octadecanoic acid, methyl ester | 801 | 2.3 |
| 18.217 | Methoxyacetic acid, tridecyl ester | 604 | 0.3 |
| 18.635 | Triethylene glycol monododecyl ether | 859 | 3.4 |
| 19.712 | Dodecanamide, N,N-bis(2-hydroxyethyl)- | 788 | 2.3 |
| 20.288 | Octaethylene glycol monododecyl ether | 729 | 3.2 |
| 21.297 | Phenol, 2-(2H-benzotriazol-2-yl)-4,6-bis(1,1-dimethylpropyl)- | 692 | 0.1 |
| 22.579 | Hexaethylene glycol monododecyl ether | 713 | 1.2 |

TABLE 3
NIST Best Match Compounds for “DISH SOAP”

| Retention | | | Abun- |
|---|---|---|---|
| Time | | Match | dance |
| (minutes) | Compound | Factor | (10*5) |
| 10.542 | 1-Dodecene | 945 | 12.5 |
| 11.616 | 1-Hexanol, 4-methyl- | 833 | 0.3 |
| 12.423 | 1-Tetradecene | 926 | 4.6 |
| 12.736 | 2-Ethyl-1-dodecanol | 789 | 2.2 |
| 13.133 | Dodecarie, 1-chloro- | 955 | 11.8 |
| 13.379 | 1-Dodecanamine, N,N-dimethyl- | 889 | 6.1 |
| 13.872 | Tridecane, 1-bromo- | 895 | 0.9 |
| 13.969 | Dodecane, 1-chloro- | 900 | 2.3 |
| 14.069 | 1-Hexadecanol | 886 | 0.9 |
| 14.760 | Tetradecane, 1-chloro- | 887 | 1.7 |
| 14.939 | 1-Tetradecanamine, N,N-dimethyl- | 813 | 2.1 |
| 15.258 | 2-Methyl-1-undecanol | 784 | 0.4 |
| 15.450 | Decane, 1-bromo- | 737 | 0.1 |
| 15.971 | 2-Methyl-1-undecanol | 795 | 0.2 |
| 16.217 | Dodecane, 1-chloro- | 794 | 0.3 |
| 17.134 | 2-Bromononane | 740 | 0.1 |
| 17.749 | Nonane, 1-iodo- | 787 | 0.1 |
| 20.318 | 1,2-Benzenedicarboxylic acid, dilsooctyl ester | 843 | 0.6 |

TABLE 4
NIST Best Match Compounds for “HYBRID CLEANING SOLUTION”

| Retention | | | |
|---|---|---|---|
| Time | | Match | Abundance |
| (minutes) | Compound | Factor | (10*5) |
| 9.061 | 2-Propanol, 1,1′-oxybis- | 748 | 2.4 |
| 9.329 | 7-Octen-2-ol, 2,6-dimethyl- | 796 | 7.4 |
| 9.649 | Methyldiethanolamine | 797 | 17.2 |
| 9.852 | Octanoic acid, methyl ester | 877 | 17.8 |
| 10.534 | 1-Dodecene | 929 | 12.7 |
| 10.726 | OctanoicAcid | 901 | 31.1 |
| 10.982 | 6-Octen-1-ol, 3,7-dimethyl- | 830 | 1.1 |
| 11.611 | Isobornyl acetate | 829 | 2.3 |
| 11.820 | Decanoic acid, methyl ester | 939 | 11.4 |
| 11.993 | p-tert-Butyl cyciohexyl-acetate cis | 845 | 0.4 |
| 12.407 | n-Decanoic acid | 816 | 24.1 |
| 12.834 | 4,7-M ethano-1H-inden-6-ol, 3a, 4, 5, 6, 7, 7a-hexahydro-, acetate | 732 | 2.1 |
| 13.133 | Dodecane, 1-chloro- | 883 | 16.0 |
| 13.394 | 1-Dodecanamine, N,N-dimethyl- | 905 | 13.3 |
| 13.564 | Dodecanoic acid, methyl ester | 901 | 81.9 |
| 14.059 | Dodecanoic acid | 932 | 87.5 |
| 14.337 | Dodecanoic acid, 1-methylethyl ester | 845 | 2.4 |
| 14.760 | 1-Hexadecanol | 846 | 2.3 |
| 14.956 | 3(N,N-Dimethylmynstylammomo)propanesulfonate | 817 | 4.3 |
| 15.085 | Methyl tetradecanoate | 885 | 32.4 |
| 15.421 | Tetradecanoic acid | 820 | 3.7 |
| 15.791 | Isopropyl Myristate | 712 | 3.1 |
| 16.187 | Galaxolide 1 | 810 | 3.6 |
| 16.483 | Hexadecanoic acid, methyl ester | 922 | 32.7 |
| 16.981 | Diethylene glycol monododecyl ether | 893 | 6.7 |
| 17.617 | 9-Octadecenoic acid, methyl ester, (E)- | 905 | 14.5 |
| 17.747 | Octadecanoic acid, methyl ester | 926 | 29.7 |
| 18.039 | Octanoic acid, dodecyl ester | 903 | 4.5 |
| 18.654 | Triethylene glycol monododecyl ether | 867 | 9.0 |
| 19.151 | Decanoic acid, decyl ester | 794 | 6.6 |
| 19.762 | Dodecanamide, N,N-bis(2-hydroxyethyl)- | 821 | 9.3 |
| 20.386 | Dodecanoic acid, dodecyl ester | 898 | 46.5 |
| 20.654 | Dodecanoic acid, undecyl ester | 697 | 3.5 |
| 21.102 | Dodecanoic acid, undecyl ester | 786 | 8.1 |
| 21.967 | Tetradecanoic acid, dodecyl ester | 841 | 14.0 |
| 22.630 | Pentaethylene glycol monododecyl ether | 828 | 6.0 |
| 22.978 | Tetradecanoic acid, hexadecyl ester | 722 | 2.3 |
| 24.236 | Hexadecanoic acid, dodecyl ester | 878 | 7.4 |
| 25.737 | Hexadecanoic acid, tetradecyl ester | 623 | 1.1 |
| 26.145 | Oxalic acid, isobutyl tridecyl ester | 678 | 0.8 |
| 26.483 | Octaethylene glycol monododecyl ether | 692 | 3.0 |
| 27.228 | Decyl oleate | 693 | 1.7 |
| 27.641 | Octadecanoic acid, dodecyl ester | 870 | 5.6 |

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

The following is claimed:

1. A cleaning solution comprising:
3.5 cups of a commercially available liquid detergent, 3.5 cups of a commercially available fabric softener, 0.5 cups of a five to ten weight percent of an ammonia in a water solution, 0.25 cups of a household bleach, 0.25 cups of a liquid dish soap, and approximately 10 cups of a distilled water.

2. The cleaning solution of claim 1, wherein the household bleach is a solution of approximately a 5.25% weight of sodium hypochlorite per unit volume of water.

3. A cleaning solution comprising:
seven volume parts a commercially available liquid detergent, seven volume parts a commercially available fabric softener, one volume part a household ammonia solution, one-half volume parts a household bleach solution, one-half volume parts a liquid dish soap, and all mixed with approximately twenty volume parts of a distilled water.

4. The cleaning solution of claim 3, wherein the household bleach is a solution of approximately a 5.25% weight of sodium hypochlorite per unit volume of water.

5. The cleaning solution of claim 3, wherein the household ammonia solution is a solution of approximately five to ten weight percent of an ammonia in a water.

6. A cleaning solution comprising:
44 fluid ounces of a commercially available liquid detergent, 38 fluid ounces of a commercially available fabric softener, 6 fluid ounces of a five to ten weight percent of an ammonia in a water solution, 8 fluid ounces of a household bleach, 12 fluid ounces of a liquid dish soap, and approximately 0.3 fluid ounces of a potassium chloride salt.

7. The cleaning solution of claim 6, wherein the potassium chloride salt is pre-dissolved in approximately 2 fluid ounces of water.

8. The cleaning solution of claim 6, wherein the household bleach is a solution of approximately a 5.25% weight of sodium hypochlorite per unit volume of water.
